(19) United States
(12) Patent Application Publication
(10) Pub. No.: US 2004/0083124 A1
(43) Pub. Date: Apr. 29, 2004

(54) Liability insurance coverage referral systems and methods

(76) Inventor: Brandt Gerard Cordelli, Vienna, VA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/661,508

(22) Filed: Sep. 15, 2003

Related U.S. Application Data
(60) Provisional application No. 60/410,309, filed on Sep. 13, 2002.

(51) Int. Cl. G06F 17/60

(52) U.S. Cl. 705/4

(57) ABSTRACT

Methods and systems for deterrmining which individual claims and/or suits submitted for a defense under a policy of liability insurance are best suited to be referred to a higher level of analysis, such as outside legal counsel for a coverage opinion and analysis. Particularly, those which allow, for example, a claims handler to quickly and efficiently make this determination, i.e., to make an automatic coverage referral.

This application claims priority benefit of U.S. Provisional Application No. 60/410,309 filed Sep. 13, 2002.

The invention described herein includes methods and systems for determining which individual claims and/or suits submitted for a defense under a policy of liability insurance are best suited to be referred to a higher level of analysis, such as outside legal counsel for a coverage opinion and analysis. Particularly, the methods and systems allow, for example, a claims handler to quickly and efficiently make this determination, i.e., to make an automatic coverage referral, thus, the systems and methods will be subsumed in the term automatic coverage referral system herein.

The system is comprised of a means for collecting relevant data based on the claim or suit and instructions for quickly and efficiently, i.e., automatically, determining from such data whether to make a coverage referral for the claim or suit. The collection of data is preferably provided on a form which may be, for example, in the nature of a paper form, electronic form, spreadsheet or any other medium suitable for ready data collection and comprehension. For the purposes of ease of description, the collection of data will be described below in terms of a paper form but the invention is not limited thereto. The form is designed to be completed by the claims handler or other initial investigator during the normal course of opening a claim file and conducting an initial investigation.

The form identifies certain categories which describe certain individual sets of circumstances that may be present with respect to the underlying claim or suit. In addition, each category may contain multiple sub-categories (“Key Facts”) which, if applicable to the underlying claim, are to be noted on the form. The sub-categories, when provided, preferably serve to elaborate upon the general category description, and inform the claims handler and anyone to whom claim may be referred of specific items which he or she should be sensitive to in handling the claim, for example, in performing the initial file opening, set up and evaluation and initial evaluation of the one referred. Sub-categories are, generally, completed only if the category is found to exist in the underlying claim.

The form also contains instructions whereby, based on the applicability of identified categories and/or subcategories, the claims handler is instructed to either: (1) automatically refer the underlying claim to a higher review level, such as outside counsel, for a coverage analysis; or, (2) refer a matter to a higher review level, such as outside counsel, subject to a review of the completed form by appropriate supervisory personnel for the purpose of determining whether to veto the referral or (3) make neither of the above referrals. As implemented, the system also provides an organized and efficient method of collecting information useful in trend analysis respecting liability claims handling efficiency, the relative expense associated with different types of claims, and the distorting effect upon overall results of extraneous, extra-contractual “coverage issues.” These types of issues, although involved in a minority of claims, tend to have a negative financial impact far greater than their numbers would suggest.

The automatic coverage referral system described is particularly intended for use by liability insurance companies and/or those who handle claims for liability insurance companies. Liability policies typically provide policyholders with two basic benefits: (1) a defense—through attorneys retained by the insurance company—to claims or suits asserted against the policyholder; and, (2) indemnification or payment of settlements or judgments for the injury or damage claimed by the third-party who has asserted the claim. Typically, the insurance company or third-party administrator (“TPA”) to whom the claims are first submitted by the policyholder initially determines whether the claim or suit is covered by a policy of insurance issued by the company. The vast majority of claims which are submitted to a carrier or TPA for possible handling under liability policies are either plainly covered, or plainly not covered, by the policy. In most cases, the personnel who are designated to handle claims at the initial level are capable of making the determination of whether or not the claim falls into either of those categories. The automatic coverage referral system is designed to deal with that minority of claims that fall in between; that is, where there is some question as to whether the claim or suit is covered under the terms of the liability insurance policy.

Determining the answer to this question is not necessarily beyond the skill or expertise of many of those who are charged with the initial handling of claims. However, because of the overall volume of claims these individuals are asked to handle on a regular basis, they simply are not able to devote the time, attention, and/or level of analysis that would be preferable for these minority of claims with “coverage issues.” As a result, the following undesired circumstances may occur: (1) claims which are not covered are, nonetheless, accepted, and payments are made for defense and/or indemnity which the company is not obligated to pay; (2) claims that are covered (or at least potentially so), and which therefore trigger a duty to hire lawyers to defend the insured, are denied, often leading to liability not only for the defense and indemnity owed under the contract terms, but also to extra-contractual liability (for so-called “bad faith”), inclusive of potential punitive damages; or, (3) contractual rights are not timely preserved in full so that, even if there is potential coverage and some obligation under the policy, the insurance carrier ends up paying more for defense and/or settlement of the claim or suit than it would otherwise be obligated to do if the contractual rights had been properly preserved.

Because of the way in which most liability insurance risks are structured, i.e., through reinsurance, there is a disincentive to refer claims out for a separate opinion or other handling by a coverage attorney. In general, when an individual insurance policy (or a class of insured risk) is reinsured, the reinsurer agrees to reimburse the direct insurer for defense expenses and indemnification costs in exchange for a portion of the premnium. Often, however, the reinsurer does not agree to reimburse the direct insurer for costs associated with retention of coverage counsel. As a result, every dollar spent on coverage counsel is an expense borne entirely by the direct insurer, and therefore, an expense that the direct insurer seeks to avoid or minimize whenever possible. Under such circumstances, the result is frequently that claims do not get referred out for a coverage opinion when they should. Alternatively, they do not get referred out until it is absolutely necessary, which often is too late to do anything other than undertake efforts at damage control.

Responses to the foregoing problem have taken different forms, from referring out all claims of a certain class, to requiring senior officers of an insurance carrier or TPA—often after going through several layers of mid-level managers—to approve such referrals. The former approach tends to incur expenses where it is not necessary to do so. The latter approach tends to create a bottleneck which delays referrals which should be made early, and generally results in, at a minimum, increased defense, indemnity, and/or coverage litigation expenses. The automatic coverage referral system invention described herein is designed to respond to the above-noted complex of problems by providing a system/method whereby the initial level claims handler can determine, simply and efficiently, whether a matter should be referred out to coverage counsel at the earliest possible stage of the process.

In one embodiment of the invention the system provides for a determination of one of three outcomes based on the data collected. The first outcome is a true “automatic” referral, whereby the initial claims handling personnel, through use of the form, can arrive at a determination that a particular matter should automatically be referred to coverage counsel. For example, this could limit the only management involvement to reporting that the referral has been made after it has been sent to outside coverage counsel. The second outcome is a “qualified automatic” determination that a particular matter should be referred to coverage counsel without management input, but allows for management to veto that determination, after a review of a fully completed form. Although this second determination requires a higher level, e.g., management, review, it differs from what is otherwise found in the industry in that it presents a pre-determined collection of necessary factual and other information in a concise, readable form that will allow the higher level reviewer, e.g., senior level management, to make whatever analysis or determination they deem necessary. It also removes the necessity of relying upon the initial claims handler's ability to spot issues, concisely summarize them, and present the pertinent facts in readable fashion, in what is often a process conducted outside of the normal claims handling function. The consistency and predictability of the form leads to ease of review thereof. The third outcome is that no automatic referral is to be made, in which case the claim will travel through the standard review system, although, again, the form will be helpful in providing a concise collection of useful data for that process.

The determination of the above outcomes is made based on collected data using a simple set of rules provided on the form. Preferably, the form provides a number of categories which either apply or do not apply to the claim. These categories may also be broken down into subsets of categories. The determination using the system is made based on how many total categories and/or how many categories of a particular subset or subsets are applicable to the claim. For example, the form may include a number, n, of categories and the instructions state that if X number of those categories apply there is an “automatic” referral and if Y categories apply there is a “qualified automatic referral.” In another preferred embodiment the instructions may state that, if X number of categories out of a first subset of categories apply, there is an automatic referral and, if Y number of categories apply out of all categories (or a different subset), there is a qualified automatic referral. The form or system is preferably set up so that the data needed to make the determination of automatic referral is the most prominent, e.g., all the needed data and instructions for automatic referral is on the front page of a front-back page form.

In a preferred embodiment of the invention, the system/method is conducted using a form that is two sided and contains several defined areas, e.g., boxes drawn with a standard table function of a word processing program. A first two such areas may be provided on the form to precede a set of instructions and are designed to capture certain identification information that is not directly involved in the process or system comprising the invention. Rather, this step seeks certain identifying facts necessary for tracking, and, particularly if completed in full, provides information useful in analyzing trends that may be associated with underlying problem areas.

For example, the form may be provided with a top left box captioned “REQUIRED INFORMATION,” and asks, for example, for the company that is issuing the policy involved, the claim number for the claim or suit submitted to the liability insurer by the policyholder, the policy number of the policy involved, the claim reviewer's name and/or a basic policy form number. This captures information that is useful primarily for two purposes: simple identification issues, and possible trend analysis with respect to, e.g., results for a particular company (many insurers are groups of insurance companies that, for various reasons, issue policies under different company names), performance by a specific claim reviewer and/or trends regarding a certain policy type. It is also useful for collection of certain key infonnation that the coverage counsel will want to know, such as the claim number and policy number. Each of these are identifying items that his or her client, the insurance carrier, will want on all correspondence.

The form may also include a second box on the top right captioned “ADDITIONAL INFORMATION.” While it is desirable that it be completed at some point during the process, it is not labeled “Required” because the difficulty of obtaining some of the requested information can contribute to a delay in the initial claims handling personnel's completion of the form. The information to be listed here is something that would be part of the reports generated after collection of data on a regular, periodic basis. As such, it is part of the usefulness of an alternate embodiment of the invention, but really only involves collection of information that will be used later to generate reports that will serve as management tools. It does not have a direct association with the automated coverage referral functionality of the invention and is, thus, optional.

Alternatively or in addition to the above-discussed “Additional Information” box, the form may contain a box, preferably non-required, for pertinent location information. Like the above-discussed “Additional Information” box, the information to be listed here is something that would be part of the reports generated after collection of data on a regular, periodic basis. As such, it is part of the usefulness of an alternate embodiment of the invention, to be used later as a trends analysis tool. For example, this aspect of the invention can be used to provide (for claims in the United States) information on the location or locations, e.g., state(s), of the named insured, of the suit, of the injury, damage or loss or of the claimant/plaintiff.

The invention makes use of instructions describing how the form is to be completed, as discussed above. These can be immediately after the preliminary boxes described above. They describe how, once completed, a determination is made as to whether the particular claim or suit qualifies for an “automatic” referral to coverage counsel, for a “qualified automatic” referral to coverage counsel, subject to branch veto, or does not qualify for a referral to coverage counsel.

The instructions describe a two step process for completing the form. The first step is to examine each of the identified categories. The design of the form may be such that the category description appears in a gray scaled top segment of a box directly beside the number of the category. The form will contain multiple such portions for the identified categories, e.g., for from 10-20 categories, particularly 14. The claims personnel will first review those category descriptions to see if any of them apply to the submitted claim or suit. The category descriptions are designed such that, in the normal course of activities associated with file opening, file set up, and preliminary analysis of a claim or suit, the claims personnel should be readily able to identify whether or not the situations described in each of the individual categories exist. Moreover, the titles of the individual categories are preferably worded to be sufficient, in and of themselves, to inform the claims personnel what he or she is actually looking for by way of the presence or absence of the described circumstances/categories.

In addition to describing the category, the top portion of the box preferably also instructs the claims personnel to indicate whether certain “Key Facts” identified within the larger category box apply, but only if the category has been indicated to be applicable. The indication of applicability of the category and of the key facts therein can be made in any of a number of ways, e.g., circling the entire box or portion of the box, checking an indicator area, highlighting, indicated in a computer-readable manner, etc.. In part, this is an exercise designed to provide the type of information, in a readily accessible format, which the higher level review personnel will use to determine whether to exercise a veto under the “qualified automatic” coverage referral situation. In part, the “Key Facts” items are also designed to serve as “flags,” or guides, to assist the claims personnel in determining whether or not a situation described in the category title exists.

As an example, Category One may be is entitled “Preliminary Analysis Suggests Denial.” Thus, in the normal course of things, claims handling personnel will develop their own opinion as to whether or not a claim may warrant a denial, based on their own experience with claims of a certain type, and the policy forms and language that are applicable. However, experience has shown that there are many underlying circumstances which claims personnel will not consider relevant immediately, but which, nonetheless, may also justify a denial. Accordingly, the listing of twelve separate items of “Key Facts” information should serve as guides that will allow the claims handling personnel to conclude that, in fact, a particular claim should be denied that, at first glance, they did not consider as warranting denial. Most of the remaining categories employ “Key Facts” itemizations that serve a similar function.

In one embodiment the system is embodied in a paper form, and is a two-sided form. However, the system can readily be embodied in a computer program viewed on a computer screen with entries made via keyboard key strokes, mouse or other computer input device. In computer form, the system can be made to have a look similar to the two-sided paper form. In the two-sided paper form or similarly arranged form, it is preferred to arrange the categories in a matter which best facilitates the system, particularly in selecting the categories which appear on the front side of the form versus the back side of the form. Preferably, the most indicative categories appear on the front side of the form, particularly such that the first determination of an outcome of “automatic” referral can be made based just from use of the front side of the form. In the embodiment described above wherein the “automatic” coverage referral occurs when X number of categories out of a subset n of the total categories is applicable, it is preferred that the entire subset of these categories appears on the front side of the form. For example, where the instructions dictate an “automatic” coverage referral when 3 of a particular 5 categories out of a total of more than 5 categories are applicable, the instructions for such and the boxes for the particular 5 categories all appear on the front side of the form. Generally, other categories will appear on the back side of the form and will include other categories that may be relevant in the selection of a “qualified automatic” coverage referral. For example, the instructions may dictate that, when there is no “automatic” coverage referral, there is still a “qualified automatic” coverage referral when 7 out of all the categories on the front and back of the form, e.g., 14 total categories, are applicable.

In another preferred embodiment of the invention using the paper forms, it is preferred if the paper form is provided on a distinctly colored paper so that it can be readily identified from other paper existing in the file. This is particularly helpful to taking advantage of the concise compilation of relevant data provided by the form.

An aspect of the invention also lies in the selection of the above-discussed categories and their hierarchy and placement on the form depending on applicability to “automatic” or “qualified automatic” referral. The categories are preferably selected from items that, experience has shown, are more likely than anything else to signal a situation where a formal coverage opinion should be obtained at the earliest possible juncture, in order to avoid increased expense and potential disaster later. Examples of the categories which the inventor has found to be particularly indicative are: 1) Preliminary Analysis Suggests Denial, 2) Mixed Suit—Covered and/or Potentially Covered with Uncovered Claims, 3) Key Policyholder Counsel Tenders Claim for Defense or Independent/Cumis Counsel Involved, and 4) Misrepresentation or Omission in Application and/or Pre-existing Loss Suspected. It is preferred that these categories appear most prominently on the form, e.g., on the front page. Other highly indicative categories are: 5) Umbrella/Excess Coverage by Company, 6) Defense Tendered by Other than Named Insured, 7) Latent and/or Continuous and Progressive Injury or Damage, 8) Other Carriers Involved, and 9) Target Claims/Damages Alleged. It is preferred that at least one of these other categories appears in the prominent, e.g., first page, of the form. In a preferred embodiment, the system provides in the most prominent area, required identifying data, the instructions or rules for “automatic” coverage referral, each of the above categories 1) to 4) and one of the above categories 5) to 9), for a total of 5 categories in this area, and wherein a determination based on the instructions can be made based only on the applicability of these 5 categories. Other pertinent categories include: 10) Internet-Related Liability Issues, 11) Potential Personal Injury or Advertising Injury, 12) Insolvent Insurer and/or Guaranty Fund Involved or On Notice, 13) SIR (Self-Insured Retention) of $100,000 or More, and 14) Employment-Related Claims. In a preferred embodiment, the system provides in the secondary prominent area, e.g., back page of form, these additional categories 10) to 14) and the categories of 5) to 9) which do not already appear on the most prominent area. As discussed above, each of the categories will preferably have a number of key facts associated with it. Examples of such key facts are provided in the Exemplary Forms ED-1 thru ED-5 and ED-7 provided as part of this disclosure.

As discussed above, preferably the first four categories appear in identical positions on all versions of the form which have been developed. The fifth category alternates from categories 5) to 9) and different versions of the systems/forms can be provided as to each possibility. The selection of the fifth category will be driven by the particular experiences of the individual insurance carrier or TPA employing the form, so some versions of the form will be more appropriate than others for individual insurers and/or TPAs.

The selection of the categories appearing on the first page of the form, particularly insofar as the first four categories are concerned, is driven by the fact that each, in some cases, could justify referral to coverage counsel in and of themselves. However, in view of the cost issues described above, the desire to refer out only those cases that truly need to be referred out, and to optimize cost efficiencies in the use of outside coverage counsel, it is preferred that no single category functions as an “automatic” trigger on its own. The first four categories will generally apply to all versions of the system, however. The preferred trigger point for “automatic” coverage referral provided by the instructions on the form is applicability of any three of the first five categories.

The categories indicated in the above-discussed embodiment as appearing on the back side of the form are categories which, in general, do not, in and of themselves, warrant referral to outside counsel. Nonetheless, the categories on the back side of the form describe circumstances which appear with some regularity in claims and/or suits that eventually give rise to coverage problems, and therefore, are appropriate for inclusion in the forms. These categories come into play in triggering a referral decision based on the instructions for “qualified automatic” coverage referral. For example, if the claims person finds that any seven of fourteen categories on the front or back of the form exist as to the underlying claim, that claim should be referred out to coverage counsel, subject to a veto by the appropriate supervisory/management personnel.

Since it is theoretically possible that seven categories will be circled, yet none on the critical first page with the top five categories will have been circled, the branch supervisory veto option is appropriate for preservation. This differs from the existing way in which these decisions are handled by insurance companies because the referral of the matter to management personnel to decide whether a coverage opinion should be obtained is not subject to any particular reporting format. Likewise, existing practice does not employ the rigorous point-bypoint test categories with “Key Facts” collected in one convenient and efficient form. Instead, the existing system generally relies upon a narrative report, or some other type of summary by the claims handler. Frequently, this does not provide all of the critical information necessary for making a quick, informed decision on whether a matter should be referred out to coverage counsel. Further, it does not provide a consistent and predictable format to facilitate efficient analysis and review.

The invention is intended for use in a software version as well, as noted above. In that circumstance, the trigger formulas described above can be used. However, other approaches particularly applicable for computer application, but also possible in paper or other applications, are also envisioned. For instance, the exemplary “three out of five” test for a pure automatic referral can be modified to some other formula (e.g., five out of the first nine, consisting of the four core categories, plus each one of the revolving five categories 5) to 9) discussed above). Alternatively, the categories can be assigned a particular weight such that, if the category is found applicable, a pre-assigned weight is tallied. Then, when the form is fully completed, the categories circled will automatically translate into a certain total overall score. The determination of whether a matter is an “automatic” referral, a “qualified automatic” referral, or no referral at all, would be based on the total score. Non-limiting examples of such weighting embodiments would include: 1) when a category is indicated, a certain weight is accorded to it without reference to what and/or how many Key Facts within the category are applicable, or what other categories, if any, may be applicable; 2) when a category is indicated, a certain weight is accorded to it, dependent upon what and/or how many Key Facts within the category are applicable, but without reference to what other categories, if any, may be applicable; or, 3) when a category is indicated, a certain weight is accorded to it, dependent upon what and/or how many Key Facts within the category are applicable, and what other categories, if any, may be applicable.

This weighting alternative is a process which can be built into a computer program that will automatically assign weights when the category is selected as applicable. The weights assigned to a particular category can also be subject to increase (or decrease) by virtue of the number and/or type of “Key Facts” which are also checked under that particular category. The weight will also be subject to increase or, potentially, decrease, based upon what other categories are, or are not, also present in the underlying claim. This entire weighting process is not something which the claims person will need to do (although they could), nor is it something he or she need even be aware is occurring. Instead, it can be an exercise (and/or a computation) performed by the computer program. Moreover, the formulation used in the computer program for calculating the weights is something that can be subject to periodic change. This will occur as the automatic coverage referral system is used more and more, because data will accumulate which may suggest that particular categories, and/or collections of “Key Facts,” and/or combinations of categories, deserve more (or less) weight than is reflected in the original computational formula used in the program.

In addition to the form/system's use as a tool to streamline the decision to refer matters out to coverage counsel, the form/system (as completed by the claims handler) will also serve to collect valuable information that will be of use to management in designing new and different systems for handling claims. It will enable insurers to reduce or eliminate the costs and/or expenses that can reasonably be traced to inefficient, ineffective—or even an absence of—claims handling procedures as they relate to coverage issues. For instance, management may learn that one of the “Key Facts” items under the first category, e.g., “Preliminary Analysis Suggests Denial”, is routinely missed by claims personnel. This would be learned by virtue of the fact that the completed form, which will be provided to coverage counsel, fails to show that item as checked, and coverage counsel would advise management that, in fact, that particular “Key Fact” did exist. Thus, management could develop new training programs to heighten awareness of particular “Key Facts” which are not being picked up in routine claims handling.

A unique feature of this system is that it collects information and initiates actions, by virtue of the “automatic” referral deterimination, that relate to the issue of claims and/or suits which are either partially, or entirely, outside the terms of coverage under the particular liability insurance policy. This is advantageous over existing systems which do not adequately address the determination of whether the claim is or is not covered by the policy, except in the most rudimentary and—as noted above—highly inefficient way. Moreover, it also captures and flags for attention those claims which are, or may be, within policy coverage, but which, for some reason, claims personnel believe are not. As noted at the outset, this represents a minority of the claims typically handled by a liability insurance policy claims operation or TPA. As such, the existing claims and processes have not been designed to address these issues in a systematic fashion.

The general consequence of the existing situation relative to handling liability insurance claims is that coverage issues are not handled properly and/or are not paid attention to as early as is preferable. The result is an increase in the costs incurred in defense of underlying claims, in payment of judgments or settlements, in “extra-contractual” exposure to the insurance company, and ultimately, in expenses paid to coverage counsel which are not covered under the company's reinsurance arrangements. The invention is designed to address this problem systematically, simply, and in a cost effective manner. It is also designed to allow claims handlers quickly to refer out those matters which should be referred out, without also referring to coverage counsel many matters which do not warrant the additional expense.

An additional management information function is provided through analysis of the information captured on a completed form. For instance, where the claims handler has determined that it was neither a “qualified,” nor an “automatic” coverage referral, but which, nonetheless, at some point, has resulted in either a lawsuit against the company by the policyholder and/or third-party claimant, or a suit by the company against the policyholder and/or third-party claimant (and/or, in some circumstances, a co-insurer). The analysis may reveal weaknesses in the claims handling system, trends in the growth or importance of certain types of coverage issues, or other information useful in avoiding coverage litigation, or otherwise handling the particular situation more economically and efficiently.

The entire disclosure of corresponding U.S. Provisional Application No. 60/410,309, filed Sep. 13, 2003 is hereby incorporated by reference.

As examples of particular embodiments of the system/methods of the invention, six examples of forms embodying the system are attached. These examples are not intended to limit the invention, for example, the invention can be repeated with similar success by substituting the generically or specifically described embodiments for those used in these examples.

From the foregoing description, one skilled in the art can easily ascertain the essential characteristics of this invention and, without departing from the spirit and scope thereof, can make various changes and modifications of the invention to adapt it to various usages and conditions.

I claim:

1. A system for making a determination of whether a claim for a defense under a liability insurance policy should be referred to a higher review level comprising:
a tangible medium setting forth a multiplicity of categories of circumstances relevant to analyzing the claim which either apply or do not apply to the claim, and
human- or computer-executable instructions for determining, from the number of categories found to apply, and optionally also from their relative importance, whether the claim should be referred to a higher review level.

2. A method for determining whether a claim for a defense under a liability insurance policy should be referred to a higher review level comprising:
making a determination whether each of a multiplicity of categories of circumstances relevant to analyzing the claim either apply or do not apply to the claim and indicating such in a tangible medium setting forth the categories, and
based on the determinations of how many categories apply, and optionally also from their relative importance, executing, by human or computer action, instructions provided on or with the tangible medium to determine whether the claim should be referred to a higher review level.

3. A system according to claim 1, wherein the instructions for determining, from the number of categories found to apply, whether the claim should be referred to a higher review level are executed by a computer.

4. A method according to claim 2, wherein the instructions for determining, from the number of categories found to apply, whether the claim should be referred to a higher review level are executed by a computer.

5. A system according to claim 1, further comprising instructions for determining, from the number of categories found to apply, whether the claim should be automatically referred to a higher review level without further analysis or referred to a higher review level with qualification of an additional analysis.

6. A method according to claim 2, further comprising instructions for determining, from the number of categories found to apply, whether the claim should be automatically referred to a higher review level without further analysis or referred to a higher review level with qualification of an additional analysis.

7. A system according to claim 5, wherein the tangible medium contains multiple categories in a primarily prominent portion of the medium from which the determination of automatic referral is made and multiple categories in a secondarily prominent portion, the determination of qualified referral being made from the categories in both such portions.

8. A method according to claim 6, wherein the tangible medium contains multiple categories in a primarily prominent portion of the medium from which the determination of automatic referral is made and multiple categories in a secondarily prominent portion, the determination of qualified referral being made from the categories in both such portions.

9. A system according to claim 7, wherein the tangible medium is a paper or electronic form, the primarily prominent portion is the first or front page of the form and the secondarily prominent portion is the second or back page of the form.

10. A method according to claim 8, wherein the tangible medium is a paper or electronic form, the primarily prominent portion is the first or front page of the form and the secondarily prominent portion is the second or back page of the form.

11. A system according to claim 8 wherein the primarily prominent portion contains five categories.

12. A method according to claim 9 wherein the primarily prominent portion contains five categories.

13. A system according to claim 11 wherein the five categories in the primarily prominent portion are: 1) Preliminary Analysis Suggests Denial; 2) Mixed Suit—Covered and/or Potentially Covered with Uncovered Claims; 3) Key Policyholder Counsel Tenders Claim for Defense or Independent/Cumis Counsel Involved; 4) Misrepresentation or Omission in Application and/or Pre-existing Loss Suspected; and one of the following: 5) Umbrella/Excess Coverage by Company, 6) Defense Tendered by Other than Named Insured, 7) Latent and/or Continuous and Progressive Injury or Damage, 8) Other Carriers Involved, or 9) Target Claims/Damages Alleged.

14. A method according to claim 12 wherein the five categories in the primarily prominent portion are: 1) Preliminary Analysis Suggests Denial; 2) Mixed Suit—Covered and/or Potentially Covered with Uncovered Claims; 3) Key Policyholder Counsel Tenders Claim for Defense or Independent/Cumis Counsel Involved; 4) Misrepresentation or Omission in Application and/or Pre-existing Loss Suspected; and one of the following: 5) Umbrella/Excess Coverage by Company, 6) Defense Tendered by Other than Named Insured, 7) Latent and/or Continuous and Progressive Injury or Damage, 8) Other Carriers Involved, or 9) Target Claims/Damages Alleged.

15. A system according to claim 13 wherein the secondarily prominent portion contains the other categories 5) to 9) not on the primarily prominent portion plus the following categories: 10) Internet-Related Liability Issues, 11) Potential Personal Injury or Advertising Injury, 12) Insolvent Insurer and/or Guaranty Fund Involved or On Notice, 13) SIR of $100,000 or More, and 14) Employment-Related Claims.

16. A method according to claim 14 wherein the secondarily prominent portion contains the other categories 5) to 9) not on the primarily prominent portion plus the following categories: 10) Internet-Related Liability Issues, 11) Potential Personal Injury or Advertising Injury, 12) Insolvent Insurer and/or Guaranty Fund Involved or On Notice, 13) SIR of $100,000 or More, and 14) Employment-Related Claims.

17. A system according to claim 1 wherein at least one category also contains associated with it one or more selectable data entries which relate to bases for finding the category applicable.

18. A method according to claim 2 wherein at least one category also contains associated with it one or more selectable data entries which relate to bases for finding the category applicable.

19. A system according to claim 15 wherein each category also contains associated with it one or more selectable data entries which relate to bases for finding the category applicable.

20. A method according to claim 16 wherein each category also contains associated with it one or more selectable data entries which relate to bases for finding the category applicable.

21. A system according to claim 1 wherein the instructions for determining whether the claim should be referred to a higher review level are based on whether a number, n, of categories out of the total categories or a selected sub-set of categories are found applicable.

22. A method according to claim 2 wherein the instructions for determining whether the claim should be referred to a higher review level are based on whether a number, n, of categories out of the total categories or a selected sub-set of categories are found applicable.

23. A system according to claim 15 wherein the instructions for determining whether the claim should be referred to a higher review level are whether three of the five categories in the primarily prominent portion are found applicable and, optionally, the instructions for determining whether the claim should be referred to a higher review level upon qualification are whether seven of a total of 14 categories in the total form are found applicable.

24. A method according to claim 16 wherein the instructions for determining whether the claim should be referred to a higher review level are whether tlree of the five categories in the primarily prominent portion are found applicable and, optionally, the instructions for determining whether the claim should be referred to a higher review level upon qualification are whether seven of a total of 14 categories in the total form are found applicable.

25. A system according to claim 1 wherein the instructions for determining whether the claim should be referred to a higher review level are based on a weighting system whereby each category is assigned a particular weighting and a certain threshold of the sum of weightings of the total categories or a sub-set of categories found applicable is met.

26. A system according to claim 15 wherein the instructions for determining whether the claim should be referred to a higher review level are based on a weighting system whereby each category is assigned a particular weighting and a certain threshold of the sum of weightings of the total categories or a sub-set of categories found applicable is met.

27. A system according to claim 25, wherein the instructions for determining whether the claim should be referred to a higher review level are executed by a computer.

28. A system according to claim 26, wherein the instructions for determining whether the claim should be referred to a higher review level are executed by a computer.

29. A method according to claim 2 wherein the instructions for determining whether the claim should be referred to a higher review level are based on a weighting system whereby each category is assigned a particular weighting and a certain threshold of the sum of weightings of the total categories or a sub-set of categories found applicable is met.

30. A method according to claim 16 wherein the instructions for determining whether the claim should be referred to a higher review level are based on a weighting system whereby each category is assigned a particular weighting and a certain threshold of the sum of weightings of the total categories or a sub-set of categories found applicable is met.

31. A system according to claim 29 wherein the instructions for determining whether the claim should be referred to a higher review level are executed by a computer.

32. A system according to claim 30, wherein the instructions for determining whether the claim should be referred to a higher review level are executed by a computer.

33. A system according to claim 1 wherein the tangible medium contains at least one data entry area for information identifying the claim.

34. A method according to claim 2 wherein the tangible medium contains at least one data entry area for information identifying the claim.

35. A system according to claim 7 wherein the tangible medium contains the instructions for determining, from the number of categories found to apply, whether the claim should be referred to a higher review level, automatically or with qualification, on the primarily prominent portion of the form.

36. A method according to claim 8 wherein the tangible medium contains the instructions for determining, from the number of categories found to apply, whether the claim should be referred to a higher review level, automatically or with qualification, on the primarily prominent portion of the form.

37. A system according to claim 1 which further includes compiling data from the tangible media prepared under the system for a multiplicity of claims and conducting a trend analysis on one or more aspects thereof.

38. A method according to claim 2 which further includes compiling data from the tangible media prepared under the method for a multiplicity of claims and conducting a trend analysis on one or more aspects thereof.
